(19) United States
(12) Patent Application Publication
(10) Pub. No.: US 2011/0214886 A1
(43) Pub. Date: Sep. 8, 2011

(54) Push On Threadless Sprinkler And Fitting

(75) Inventor: Shawn G. Orr, Grand Rapids, MI (US)

(73) Assignee: THE VIKING CORPORATION, Hastings, MI (US)

(21) Appl. No.: 13/037,406

(22) Filed: Mar. 1, 2011

Related U.S. Application Data
(60) Provisional application No. 61/310,756, filed on Mar. 5, 2010.

(51) Int. Cl. A62C 35/00; F16L 39/00

(52) U.S. Cl. 169/37; 285/321

(57) ABSTRACT

A threadless fitting for fluidly coupling a sprinkler assembly to a pipe is provided. The sprinkler assembly includes a body having an orifice extending therethrough for fluid communication with the pipe. The fitting may include an inner annular member including a plurality of prongs extending radially inward therefrom. The plurality of prongs may be angled away from an outlet of the fitting to allow the body of the sprinkler assembly to be inserted into the fitting and prevent the body from being retracted from the fitting.

### CROSS-REFERENCE TO RELATED APPLICATIONS

This application claims the benefit of U.S. Provisional Application No. 61/310,756, filed Mar. 5, 2010. The entire disclosure of the above application is incorporated herein by reference.

### FIELD

The present disclosure relates to fire protection sprinklers, and more particularly to a push-on threadless sprinkler and fitting.

### BACKGROUND

This section provides background information related to the present disclosure which is not necessarily prior art.

Fire protection sprinklers are commonly connected to supply pipes installed above ceilings and/or behind walls of a building or room. Such sprinklers may disperse water, foam, or other fire suppressant material to suppress or extinguish a fire. Typically, fire protection sprinklers include male threads that engage mating female threads in a fitting in the supply pipe. To ensure that the sprinkler is securely fixed to the pipe and to prevent leakage between the sprinkler and the pipe, the threaded connection must be tightened to a predetermined minimum torque. Installation of such sprinklers can be relatively labor intensive and time consuming, especially when numerous sprinklers must be installed or serviced throughout an entire building.

Furthermore, human error in the installation process can lead to a number of problems. For example, over-tightening the threaded connection can cause damage to the sprinkler and/or fitting and cause leaks, while under-tightening the threaded connection may also lead to leakage. Cross-threading between the threads of the sprinkler and the threads of the fitting can damage either or both sets of threads and can compromise the integrity of the seal between the sprinkler and the fitting. Repeatedly installing and uninstalling such threaded connections can damage the threads and limit the useful life of the sprinkler and/or pipe fitting.

### SUMMARY

This section provides a general summary of the disclosure, and is not a comprehensive disclosure of its full scope or all of its features.

In one form, the present disclosure provides a fitting for fluidly coupling a sprinkler assembly to a pipe. The sprinkler assembly includes a body having an orifice extending therethrough for communication with the pipe. The sprinkler assembly can further include a closure device and a leak responsive trigger. The fitting may include an outer annular member and an inner annular member. The outer annular member may engage an inner diameter of the pipe. The inner annular member may include a plurality of prongs extending radially inward therefrom. The plurality of prongs may be angled radially inward away from an outlet of the fitting to allow the body of the sprinkler assembly to be inserted into the fitting and prevent the body from being retracted from the fitting.

In another form, the present disclosure provides a sprinkler system that may include a supply pipe, a sprinkler assembly, and a fitting. The sprinkler assembly may include a body having an orifice in communication with the supply pipe, a frame extending from the body, and a heat-responsive trigger mechanism disposed between the frame and an outlet of the orifice. The heat-responsive trigger mechanism may releasably retain a plug for sealing the outlet. The fitting may be at least partially received in or received on the supply pipe and may include an outer portion engaging an inner diameter of the supply pipe and a ring disposed within the outer portion. The ring may include a plurality of resilient tabs extending radially inward and releasably engaging an outer diameter of the body. The body may be pressed into engagement with the fitting.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial perspective view of a sprinkler system including a threadless fitting according to the principles of the present disclosure;

FIG. 2 is an exploded perspective view of the sprinkler system of FIG. 1;

FIG. 3 is a cross-sectional view of the threadless fitting engaging a supply pipe and a sprinkler body;

FIG. 4 is a cross-sectional view of a sprinkler assembly being inserted into the threadless fitting according to the principles of the present disclosure;

FIG. 5 is a cross-sectional view of the sprinkler assembly installed into the threadless fitting according to the principles of the present disclosure; and

FIG. 6 is a cross-sectional view of the sprinkler assembly being uninstalled from the threadless fitting according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

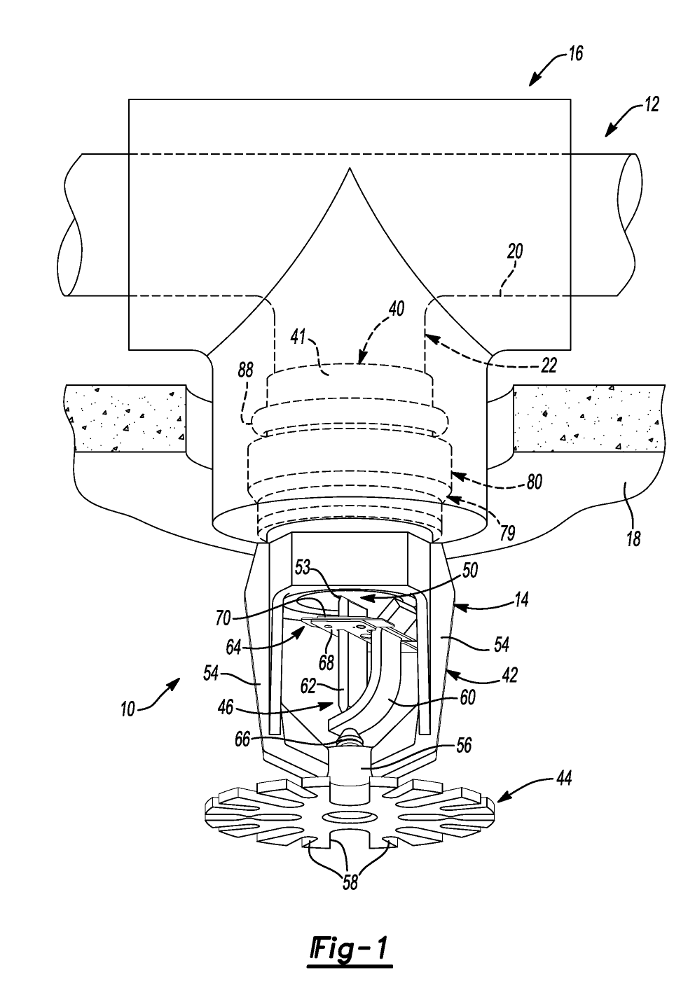

With reference to FIGS. 1-6, a sprinkler system 10 is provided and may include a supply pipe 12, a sprinkler assembly 14, and a threadless fitting 16. The sprinkler assembly 14 engages the supply pipe 12 via the fitting 16 and may be disposed in or near a ceiling 18 or sidewall of a building, for example. The sprinkler assembly 14 discharges a fire suppressant in response to exposure to a predetermined level of heat, as will be subsequently described. It will be appreciated that the sprinkler assembly 14 could be an upright, pendant, horizontal sidewall, or other sprinkler and could be installed in any type of building or structure and in any desirable location within the building or structure.

The supply pipe 12 may be a water pipe, for example, adapted to supply water to the sprinkler assembly 14. It will be appreciated that the supply pipe 12 could supply any fire suppressant or fire extinguishing fluid or substance such as, for example, water, a fire suppressing foam, powder, liquid, gas, or any other substance operable to suppress, extinguish or reduce the propagation of a fire. Accordingly, the term “fire suppressant,” as used herein, is meant to include any such fluid or substance.

The supply pipe 12 may be a metallic or heat-resistant polymeric conduit including a main line 20 in fluid communication with one or more outlets 22. Each outlet 22 may at least partially receive one of a plurality of sprinkler assemblies 14 spaced apart from each other at a predetermined distance (not shown) in the room, building or structure. It will be appreciated that the distance between outlets 22 may be predetermined based on the area over which the sprinkler assemblies 14 discharge the fire suppressant. Each outlet 22 may cooperate with the main line 20 to form a generally T-shaped or L-shaped joint. The outlets can be integrally formed with the main line 20 or can be attached to the main line by other tubing and/or fittings.

The outlet 22 may be threadless and may include first, second, and third annular recesses 24, 26, 28, respectively. The first annular recess 24 may include a first diameter 30, a second diameter 32 disposed at a distal end 34 of the outlet 22, and a tapered surface 36 connecting the first and second diameters 30, 32. The second annular recess 26 may be disposed upstream from the first annular recess 24 and adjacent to the first diameter 30, with a first shoulder 31 disposed therebetween. The third annular recess 28 may be disposed upstream from the second annular recess 26 and adjacent thereto, with a second shoulder 33 disposed therebetween.

The sprinkler assembly 14 may include a sprinkler body 40, a frame 42, a deflector 44, and a trigger assembly 46. While the sprinkler assembly 14 shown in FIG. 1 is an exposed sprinkler assembly, it will be appreciated that the sprinkler assembly 14 could be a concealed sprinkler assembly of the type disclosed in U.S. Pat. No. 6,152,236, for example, the disclosure of which is hereby incorporated by reference as if fully set forth herein.

The sprinkler body 40 may be a generally cylindrical member having a threadless outer diameter surface 41 that is secured to the outlet 22 of the supply pipe 12 via the threadless fitting 16, as will be subsequently described. The sprinkler body 40 may include a central orifice 48 in fluid communication with the supply pipe 12. A sealing assembly 50 may be used to seal the central orifice 48 of the sprinkler body 40. Sealing assembly 50 includes plug 50A and sealing spring 52. Sealing spring 52 is positioned within outlet of orifice 48 and is supported by shoulder 49′ of the body 40. Sealing spring 52 contains a central aperture 52′ dimensioned to be disposed against the seat 51. The sealing assembly 50 will seal the orifice 48 to prevent the fire suppressant from flowing therethrough until the trigger assembly is actuated. The plug 50A may include an outward facing surface having a slot 53, as shown in FIG. 1. The sealing assembly 50 may include other configurations including a spring seal or other known plug structures.

The frame 42 may include one or more frame arms 54 and an apex 56. The frame arms 54 may extend from the sprinkler body 40 and may support the deflector 44 at a predetermined distance apart from the orifice 48. The frame arms 54 may be substantially rigid members providing structural support for the deflector 44 and clearance for the trigger assembly 46 between the orifice 48 and the deflector 44.

The deflector 44 may be a generally circular disk having a plurality of slots, apertures and/or cutouts 58. The deflector 44 may be formed to manipulate the flow or alter a trajectory of the fire suppressant through the sprinkler assembly 14 to achieve a desired spray pattern, as is known in the art. Accordingly, the deflector 44 can have any suitable shape, size, or pattern of slots, apertures and/or cutouts to achieve a desired fire suppressant flow pattern.

It will be appreciated that the sprinkler body 40, frame 42 and deflector 44 may be formed from a metallic material or any other material or combination of materials suited to provide structural integrity and heat resistance. The sprinkler body 40, the frame 42 and the deflector 44 can be integrally formed, welded, staked, or threadably fastened to each other, for example, or otherwise suitably joined.

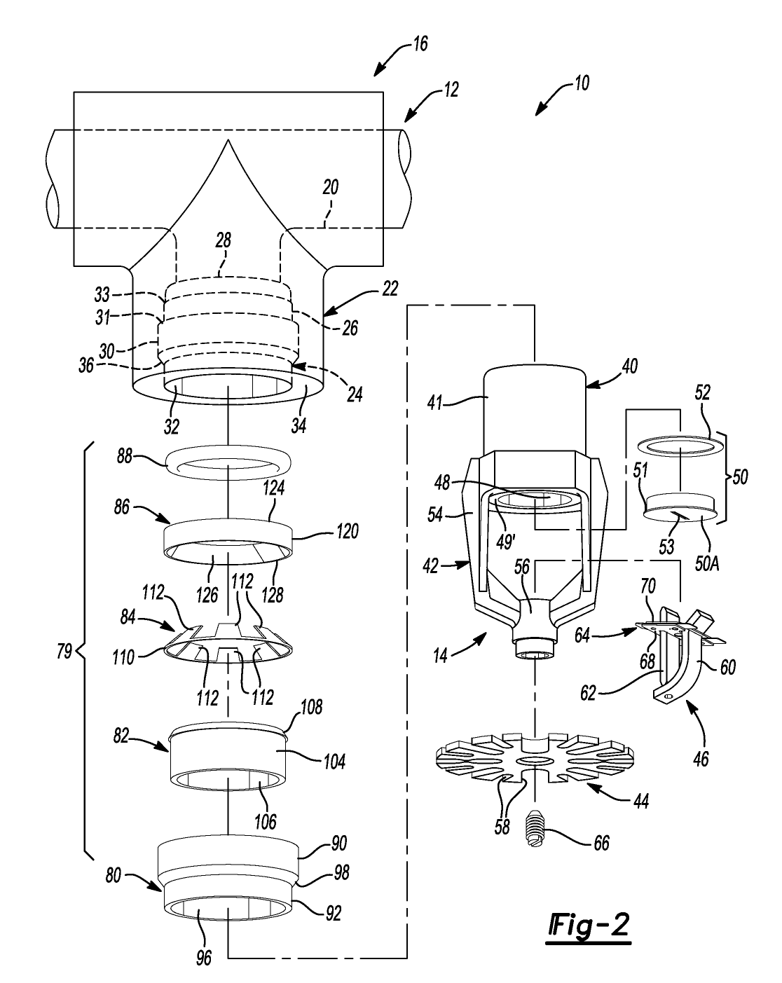

The trigger assembly 46 may be any suitable heat-responsive mechanism that is able to be actuated to release the plug 50 from the orifice 48 and allow the fire suppressant to flow through the orifice 48 in response to exposure to a predetermined level of heat from a fire or other heat source. For example, the trigger assembly 46 may include a glass bulb or any linkage system of known design. Briefly, an exemplary trigger assembly 46, as shown in FIG. 2, may include a first member or pin 60, a second member or pin 62, a fusible link 64, and an adjustment member 66 in the form of a compression screw. The fusible link 64 may include first and second plates 68, 70 soldered together and engaging the first and second pins 60, 62. In response to exposure to the predetermined level of heat, the solder of the fusible link 64 may melt, thereby allowing the first and second plates 68, 70 to separate and release the first and second pins 60, 62.

Further description of the structure and function of exemplary plugs and trigger assemblies are provided in U.S. Pat. Nos. 7,290,618, 6,962,208 and 6,152,236, and U.S. Patent Application Publication No. 2007/0187116, the disclosures of which are hereby incorporated by reference as if fully set forth herein.

The threadless fitting 16 can include a T-fitting (as shown), an elbow fitting, a straight fitting, or other configuration depending upon the desired application. The threadless fitting 16 includes a retainer assembly 79 that can include an outer annular member 80, a disengagement member 82, an engagement member 84, a support member 86, and an O-ring seal 88. The outer annular member 80, the disengagement member 82, the engagement member 84, and the support member 86 may be formed from one or more metallic and/or heat-resistant polymeric materials, for example. The O-ring seal 88 may be formed from a resilient rubber, for example, or other polymeric or resilient material. As will be subsequently described, the threadless fitting 16 may releasably receive the sprinkler body 40 to provide fluid communication between the supply pipe 12 and the orifice 48 of the sprinkler assembly 14.

The outer annular member 80 may be formed from a metallic or heat-resistant polymeric material and may include first and second outer surfaces 90, 92 and first and second inner surfaces 94, 96. A tapered surface 98 may be disposed between the first and second outer surfaces 90, 92. Adjacent first and second annular flanges 100, 102 may be disposed between the first and second inner surfaces 94, 96. The outer annular member 80 may be received at least partially within the first annular recess 24 of the outlet 22 of the fitting 16 such that the first outer surface 90 engages the first diameter 30 and the second outer surface 92 engages the second diameter 32 of the first annular recess 24. The outer annular member 80 may be fixed within the first annular recess 24 of the outlet 22 via socket welding, a snap fit, a press or interference fit, a set screw, a threaded connection, and/or any other suitable fastening means.

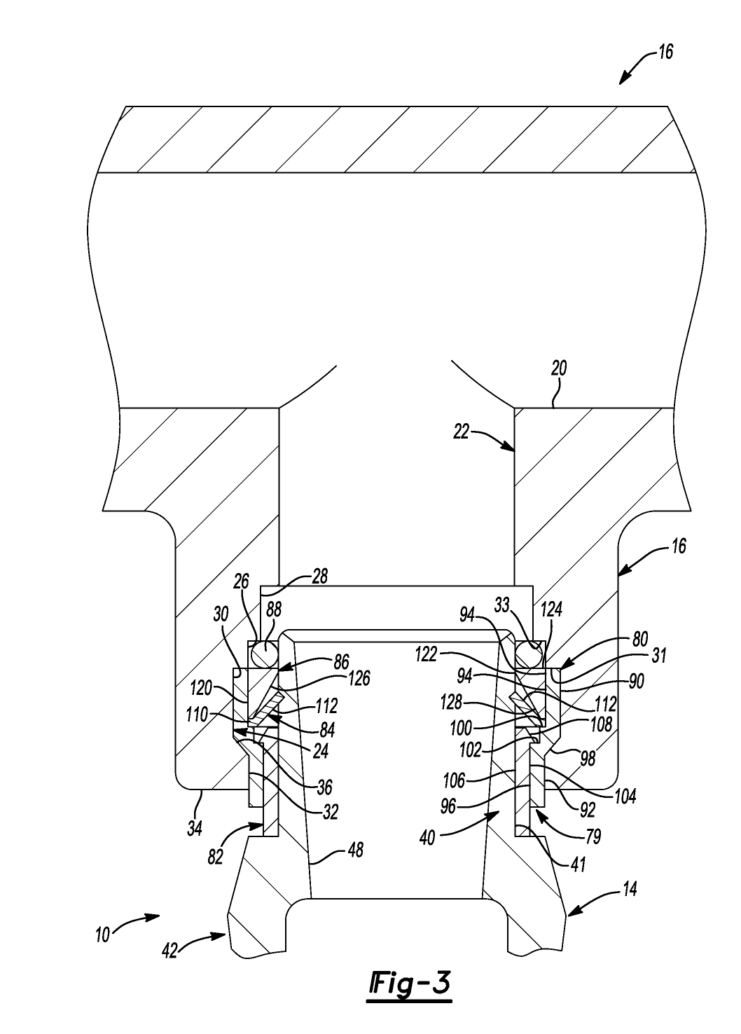

The disengagement member 82 may be a generally cylindrical annular member having a radially outer surface 104 and a radially inner surface 106. The radially outer surface 104 may include an annular lip or barb 108. The disengagement member 82 may be at least partially received within the outer annular member 80 such that the outer surface 104 of the disengagement member 82 is slidably engaged with the second inner surface 96 of the outer annular member 80. The disengagement member 82 may be axially movable between a first position (FIGS. 3-5) and a second position (FIG. 6). In the first position, the barb 108 abuts the second annular flange 102 of the outer annular member 80. In the second position, the barb 108 is spaced apart from the annular flange 102. The disengagement member 82 can be provided with engagement recesses or other features that allow the disengagement member 82 to be engaged by a tool to move the disengagement member into a disengaging position.

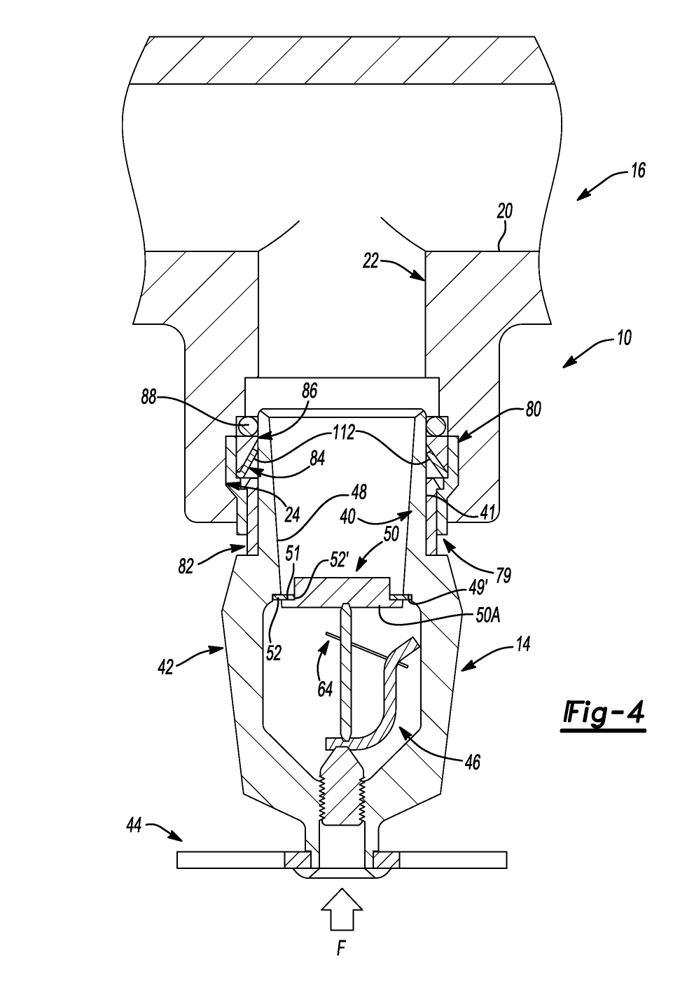

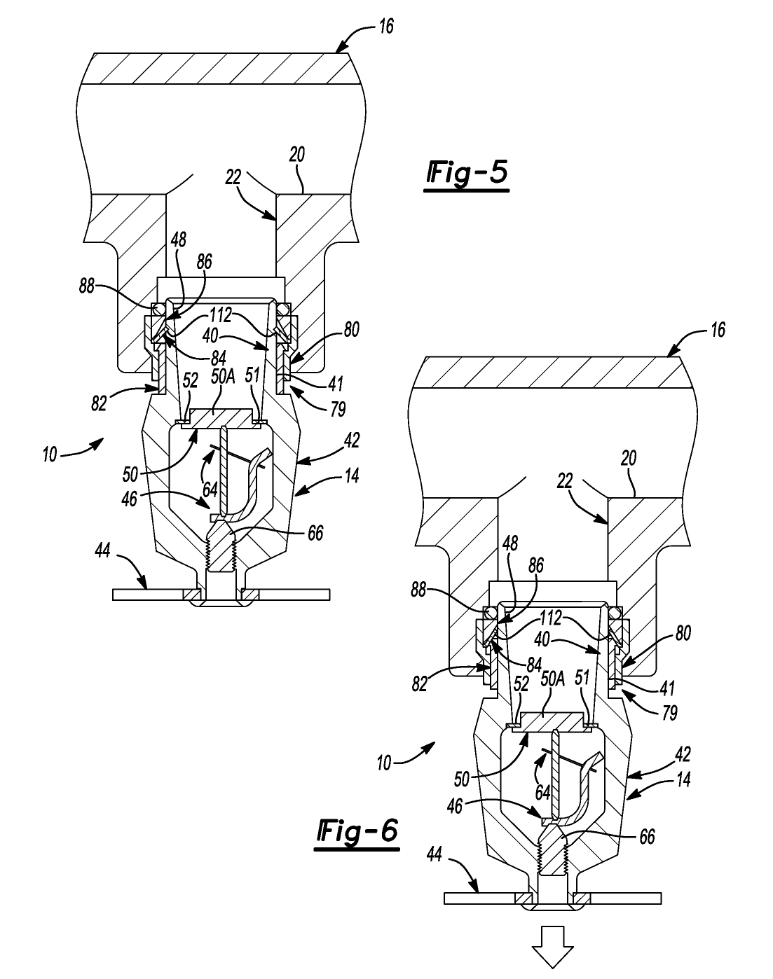

The engagement member 84 may include an annular base 110 and a plurality of relatively thin tabs or prongs 112 extending radially inward from the annular base 110 and away from the distal end 34 of the outlet 22. The annular base 110 may engage the first inner surface 94 and the first annular flange 100 of the outer annular member 80. The prongs 112 may releasably engage the outer diameter surface 41 of the sprinkler body 40. The prongs 112 may be resiliently flexible at or near the annular base 110 such that the prongs 112 may be bent upward into a disengaged position (FIGS. 4 and 6) and subsequently return to a nominal position or engaged position (FIGS. 3 and 5).

The support member 86 may be an annular member including a generally cylindrical outer surface 120, a generally cylindrical inner surface 122 disposed at a first end 124 of the support member 86, and a tapered inner surface 126 extending between the inner surface 122 and a second end 128. The outer surface 120 may be received within the first inner surface 94 of the outer annular member 80. The inner surface 122 may slidably engage the outer diameter surface 41 of the sprinkler body 40. The first end 124 of the support member 86 may abut the O-ring seal 88. The second end 128 of the support member 86 may abut the annular base 110 of the engagement member 84.

The O-ring seal 88 may be seated against the second annular recess 26 of the outlet 22 and the first end 124 of the support member 86. The O-ring seal 88 may provide a fluid-tight seal between the outlet 22 of the supply pipe 12 and the outer diameter surface 41 of the sprinkler body 40. Additionally or alternatively, any suitable sealing member could cooperate with or replace the O-ring seal 88 to provide a sealed relationship between the outlet 22 and the outer diameter surface 41 of the sprinkler body 40.

While the outer annular member 80, the engagement member 84, and the support member 86 are shown in the Figures as separate and discrete components, in other configurations, any of the outer annular member 80, the engagement member 84, and/or the support member 86 could be integrally formed with another one or more of the outer annular member 80, the engagement member 84, and/or the support member 86.

With particular reference to FIGS. 3-6, operation of the retainer assembly 79 will be described in detail. As described above, the retainer assembly 79 may be securely received in the outlet 22 of the fitting 16 and may releasably retain the sprinkler assembly 14 for fluid communication with the fitting 16. The sprinkler body 40 may be pressed into engagement with the fitting 16. In this manner, the fitting 16 allows fast, simple and robust threadless installation of the sprinkler assembly 14 onto the supply pipe 12. The threadless engagement between the sprinkler assembly 14 and the fitting 16 eliminates the need to apply a torque to the sprinkler assembly 14 to provide a seal between the outlet 22 and the sprinkler body 40, thereby reducing internal stresses in the sprinkler assembly 14 and the fitting 16.

An installation technician or other person may install the sprinkler assembly 14 by inserting the sprinkler body 40 into the fitting 16 and applying a force F (FIG. 4) to the sprinkler assembly 14 in an upward direction (relative to the view shown in FIG. 4). As the sprinkler body 40 is inserted through the engagement member 84, the upward force of the outer diameter surface 41 of the sprinkler body 40 against the prongs 112 bends the prongs 112 upward (FIG. 4) against the tapered surface 126 of the support member 86. The sprinkler body 40 may be inserted into the outlet 22 to a depth at which the outer diameter surface 41 of the sprinkler body 40 sealingly engages the O-ring seal 88.

Once the sprinkler body 40 is pressed into the fitting 16, the installation technician may simply let go of the sprinkler assembly 14. As the force of gravity and/or any other forces urge the sprinkler assembly 14 to back out of the outlet 22 (i.e., in a downward direction relative to the views shown in FIGS. 4 and 5), the resiliency of the prongs 112 will urge the prongs 112 back toward the engaged position (FIG. 5) and apply an inward force on the outer diameter surface 41 of the sprinkler body 40. The opposing forces of all of the plurality of prongs 112 simultaneously acting on the outer diameter surface 41 will have a gripping effect on the sprinkler body 40, thereby retaining the sprinkler body 40 in the fitting 16 against any forces urging the sprinkler body 40 out of the outlet 22, as shown in FIG. 5.

As described above, the annular base 110 of the engagement member 84 is fixed in an axial direction between the first annular flange 100 of the outer annular member 80 and the second end 128 of the support member 86. The engagement member 84 may be rotatable relative to the outer annular member 80 and/or the outlet 22. Accordingly, the sprinkler assembly 14 may be rotatable relative to the outlet 22 even while the prongs 112 are gripping the sprinkler body 40 and the sprinkler assembly 14 is fully installed.

To remove the sprinkler assembly 14 from the outlet 22 for service or replacement, for example, the installation technician may apply a force to the disengagement member 82 causing the disengagement member 82 to move in an upward axial direction relative to the outer annular member 80 urging the prongs 112 into the disengaged position (FIG. 6). As disengagement member 82 forces the prongs 112 into the disengaged position, the gripping forces exerted on the outer diameter surface 41 of the sprinkler body 40 are released, allowing the sprinkler body 40 to be removed from the fitting 16. Once the sprinkler body 40 is sufficiently removed from the retainer assembly 79 such that the outer diameter surface 41 is clear of the prongs 112, the installation technician may release the disengagement member 82 and allow the prongs 112 to spring back to their nominal (or unbiased) position.

As described above, the sprinkler body 40 may be pressed into the fitting 16 for a sealed connection and is prevented from disengaging from the fitting 16 until the disengagement member 82 forces the prongs 112 into the disengaged position. This process of the installing and uninstalling the sprinkler assembly 14 onto the fitting 16 may be repeated multiple times, as necessary, without damaging the fitting 16 or the sprinkler assembly 14.

It should be appreciated that the prongs 112 may or may not deform or dig into the outer diameter surface 41 to the extent or depth shown in FIG. 5. Any indentations or deformations in the outer diameter surface 41 made by the gripping force of the prongs 112 may be increased or decreased based on the mechanical and material properties of the prongs 112 and the sprinkler body 40. For example, the stiffness of the prongs 112 and the hardness of the material from which the sprinkler body 40 is formed will influence the depth at which the prongs 112 engage the sprinkler body 40. It will be appreciated that fluid pressure in the supply pipe 12 will exert a force on the sprinkler assembly 14 that will bias the sprinkler body 40 out of engagement with the fitting 16 and the outlet 22. Accordingly, the mechanical and material properties and the geometry of prongs 112 should be selected such that the gripping force that the prongs 112 are capable of exerting on the sprinkler body 40 are sufficient to withstand forces due to fluid pressure and gravity.

While the fitting 16 is described above as gripping or digging into the outer diameter surface 41 of the sprinkler body 40, in other configurations, the sprinkler body 40 could include an annular recess (not shown) adapted to engage the plurality of prongs 112 via a snap fit, for example.

While not specifically shown in the Figures, the fitting 16 could be provided with additional retainer assemblies 79 used to couple adjacent sections of the pipe, for example, or any adjacent fluid conduits.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A fire protection sprinkler system, comprising:
a fluid supply pipe;
a fitting attached to said fluid supply pipe, the fitting including a threadless retainer assembly; and
a sprinkler assembly including a body having an orifice extending therethrough, said body including a threadless outer surface and said threadless retainer assembly including an inner annular member having a plurality of prongs extending radially inward therefrom, said plurality of prongs being angled away from a distal end of an outlet of said fitting for engaging said threadless outer surface of said body, thereby allowing said body of said sprinkler assembly to be inserted into said fitting and preventing said body from being retracted from the fitting, and a sealing member disposed between said outer diameter of said body and an inner diameter of said fitting to provide a water-tight seal therebetween.

2. The sprinkler system of claim 1, wherein said inner annular member is rotatable relative to said fitting.

3. The sprinkler system of claim 1, further comprising an axially movable ring at least partially received within said fitting and movable between a first position allowing said plurality of prongs to engage said threadless outer surface of said body and a second position disengaging said plurality of prongs from said body to allow said body to be retracted from the fitting.

4. The sprinkler system of claim 3, wherein said plurality of prongs are resiliently flexible to allow the fitting to be reused.

5. A sprinkler system comprising:
a supply pipe;
a sprinkler assembly including a body having an orifice in communication with said supply pipe, a frame extending from said body, and a heat-responsive trigger mechanism disposed between said frame and an outlet of said orifice and releasably retaining a plug sealing said outlet; and
a fitting attached to said supply pipe and a ring disposed within said fitting and including a plurality of resilient tabs extending radially inward and releasably engaging an outer diameter of said body of said sprinkler assembly,
wherein said body is pressed axially into engagement with said fitting.

6. The sprinkler system of claim 5, wherein a portion of said fitting engaging said body of said sprinkler assembly is threadless.

7. The sprinkler system of claim 6, wherein said body of said sprinkler is threadless.

8. The sprinkler system of claim 5, wherein said plurality of resilient tabs are angled to allow said body to be axially inserted into said fitting while preventing said body from being retracted therefrom.

9. The sprinkler system of claim 5, further comprising a sealing member disposed between said outer diameter of said body and an inner diameter of said fitting to provide a fluid-tight seal therebetween.

10. The sprinkler system of claim 5, wherein said ring is rotatable relative to said supply pipe.

11. The sprinkler system of claim 5, further comprising an axially movable ring at least partially received in said fitting and adapted to selectively bias said plurality of resilient prongs out of engagement with said body.
